(19) United States
(12) Patent Application Publication
(10) Pub. No.: US 2019/0094018 A1
(43) Pub. Date: Mar. 28, 2019

(54) METHOD FOR MEASURING THE AXIAL RUNOUT OF A PLANE SURFACE OF A WORKPIECE WITH RESPECT TO AN AXIS OF ROTATION, AND CORRESPONDING MEASURING ASSEMBLY

(71) Applicant: Marposs Societa' Per Azioni, Bentivoglio (BO) (IT)

(72) Inventors: Domenico Malpezzi, Brisighella (RA) (IT); Alessandro Rossi, S. Agostino (FE) (IT)

(73) Assignee: Marposs Societa' Per Azioni, Bentivoglio (BO) (IT)

(21) Appl. No.: 16/086,344

(22) PCT Filed: Mar. 20, 2017
(86) PCT No.: PCT/EP2017/056493

§ 371 Date: Sep. 19, 2018

(30) Foreign Application Priority Data
Mar. 21, 2016 (IT) 102016000028955

(51) Int. Cl. G01B 11/27; G01B 11/24

(52) U.S. Cl. CPC G01B 11/272; G01N 2021/8829; G01B 11/2433

(57) ABSTRACT

A method for measuring the axial runout of a plane surface (22) of a workpiece (2) with respect to an axis of rotation (6) by means of a linear image sensor (19), in which a first optical scanning of the non-rotating workpiece is performed by translating the sensor relative to the workpiece along a direction (Z) parallel to the axis of rotation to obtain a first light intensity trend (I1) of a pixel (23) as the relative position between the workpiece and the sensor varies, and a relative position (ZR) of plane surface is determined as a function of the first light intensity trend. A second optical scanning of the workpiece is performed in the relative position of the plane surface while the workpiece rotates with respect to the axis for obtaining a second light intensity trend (I2) of the pixel as the angular position (θ) of the workpiece varies. A maximum position value and a minimum position value (Zmax, Zmin) are determined from the first light intensity trend using, as input data, light intensity values derived, or obtained by processing, by the second light intensity trend, and the axial runout is calculated as the difference between the maximum and minimum position values.

### TECHNICAL FIELD

The present invention relates to a method for measuring the axial runout or orthogonality error of a plane surface of a workpiece with respect to an axis of rotation, and to a corresponding measuring assembly.

In particular, the present invention finds advantageous, but not exclusive, application in a measuring assembly for measuring dimensional shape or position parameters of mechanical parts, such as automotive engine, to which the following description will make explicit reference without losing generality.

### BACKGROUND ART

A known measuring assembly for measuring workpieces or mechanical parts comprises a fixed frame, a motorized rotating holding mechanism, which is mounted on the fixed frame to retain the workpiece at two axially spaced apart ends thereof and to rotate the workpiece about an axis, a longitudinal guide parallel to the axis, a motorized movable frame which is adapted to translate along the longitudinal guide and includes a fork having two arms arranged on opposite sides of the workpiece, and an optoelectronic probe mounted on the movable frame to acquire linear images of the workpiece, transverse to its own axis.

In particular, the optoelectronic probe comprises an illuminator, which is arranged on an arm of the movable frame so as to emit a beam of rays parallel to a plane orthogonal to the workpiece axis, and a linear image sensor, which is arranged on the other arm of the movable frame so as to be aligned with the illuminator for acquiring images of the workpiece according to the shadow casting technique.

The measurement assembly also comprises an electronic control unit configured to control the rotating holding mechanism, the movable frame and the optoelectronic probe according to a plurality of sequences of operations selectable by an operator to check various dimensional, shape or position features or parameters of the workpiece. One of these parameters is the orthogonality error of a plane surface of the workpiece relative to its axis of rotation, also known as axial TIR (Total Indicator Reading) or axial runout.

The checking or measurement process of the axial runout usually comprises the steps of:

rotating the workpiece about its own axis so as to arrange it in a sequence of angular positions evenly distributed in a 360° revolution;

at each angular position, performing an optical scanning of the workpiece, and obtaining images while shifting the optoelectronic probe along a scanning direction parallel to the axis;

on the basis of an image obtained by each optical scanning, determining, along said scanning direction, the position of the plane surface of the workpiece; and

calculate the axial runout based on all positions of the plane surface.

In a single optical scanning performed at a certain angular position a sequence of linear images is acquired by the optoelectronic sensor according to a predetermined rate along the scanning direction parallel to the axis of the workpiece and to put together these images into a single two-dimensional image.

The above-mentioned checking process has the obvious disadvantage of a rather long cycle time, since it is necessary to perform a high number of scannings parallel to the axis of the workpiece, that is, a scanning for each of the angular positions.

### DISCLOSURE OF THE INVENTION

An object of the present invention is to provide a method for measuring the axial runout of a plane surface of a mechanical piece, such method having a short cycle time and, at the same time, being easy and inexpensive to put into practice.

It is also an object of the present invention to provide a measuring or checking assembly for carrying out such method.

In accordance with the present invention, there are provided a method for measuring the axial runout of a plane surface of a workpiece with respect to an axis of rotation, and an assembly for measuring the axial runout of a plane surface of a workpiece with respect to an axis of rotation, as defined in the appended claims.

### BRIEF DESCRIPTION OF THE DRAWINGS

The present invention will now be described with reference to the accompanying drawings, which illustrate a non-limiting embodiment, in which:

FIG. 1 is a perspective view of an assembly for measuring parameters of a mechanical part, configured to implement the method for measuring the axial runout of a plane surface of the workpiece according to the present invention;

FIG. 2 is a different perspective view of a part of the assembly of FIG. 1;

FIG. 3 illustrates, in schematic manner, the performance of a phase of the method for measuring the axial runout according to the present invention;

FIG. 4 illustrates an example of an intermediate result of the method for measuring the axial runout according to the present invention; and

FIG. 5 illustrates an example of a further intermediate result of the method for measuring the axial runout according to the present invention.

### BEST MODE OF CARRYING OUT THE INVENTION

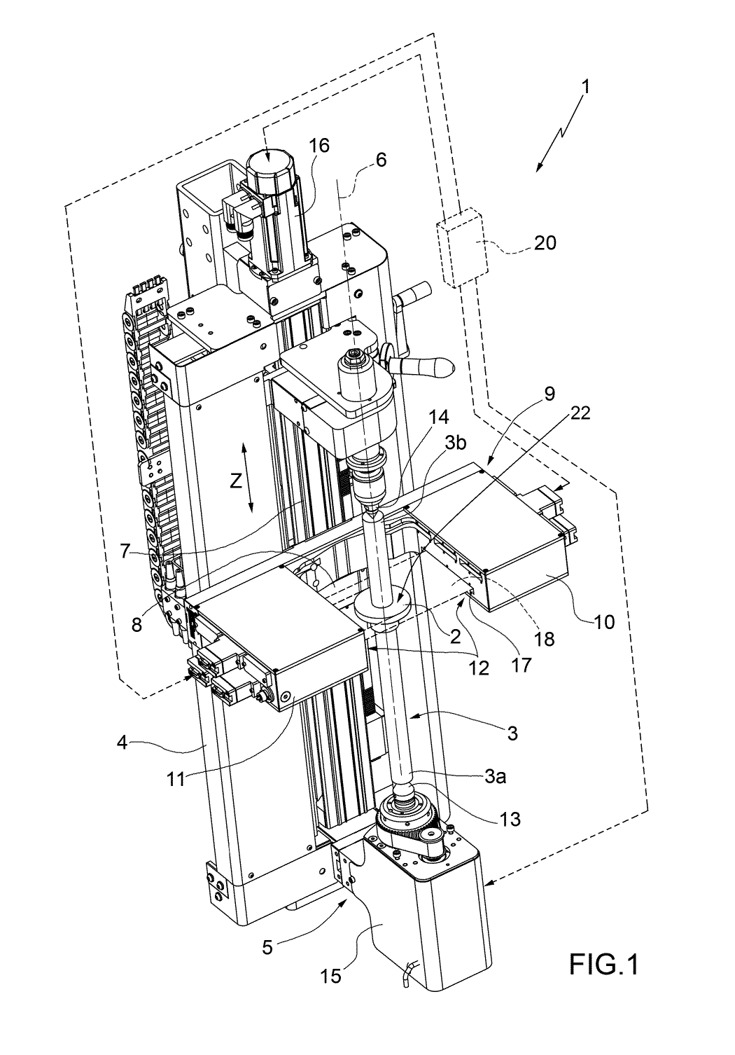

In FIG. 1, a measuring or checking assembly for measuring various parameters of a workpiece 2 is indicated with reference number 1. In the particular example of FIG. 1, the workpiece 2 is a disk shaped portion including a plane surface 22 defining a symmetry axis and being part of a shaft 3. With reference to FIG. 1, the measuring assembly 1 comprises: a fixed frame 4; a motorized rotating holding mechanism 5, which is mounted on the fixed frame 4 for axially retaining the shaft 3, and so the workpiece 2, and for rotating it about an axis of rotation 6 that is, for example, coincident the symmetry axis of the workpiece 2; a longitudinal guide 7, on the fixed frame 4, which extends along a Z direction parallel to the axis of rotation 6; a movable support with a slide 8, which is adapted to translate on the longitudinal guide 7 along the Z direction, and comprises a fork 9 with two arms 10 and 11 arranged on opposite sides with respect the axis of rotation 6, and an optoelectronic sensor 12, which is mounted on the fork 9 to acquire linear images of the workpiece 2 transverse to the axis of rotation 6.

In the example shown in FIG. 1, the rotating holding mechanism 5 is of the type comprising a headstock with a live center 13 and a tailstock with a dead center 14 adapted to hold the shaft 3 at axial ends 3a and 3b thereof. A motor 15, integral with the fixed frame 4, is adapted to put into rotation the live center 13, while the dead center 14 can idly rotate. Preferably, the rotating holding mechanism 5 is arranged so that the axis of rotation 6 is vertical. The slide 8 is kinematically coupled, preferably via a threaded coupling, not shown, to another motor 16 integral with the fixed frame 4.

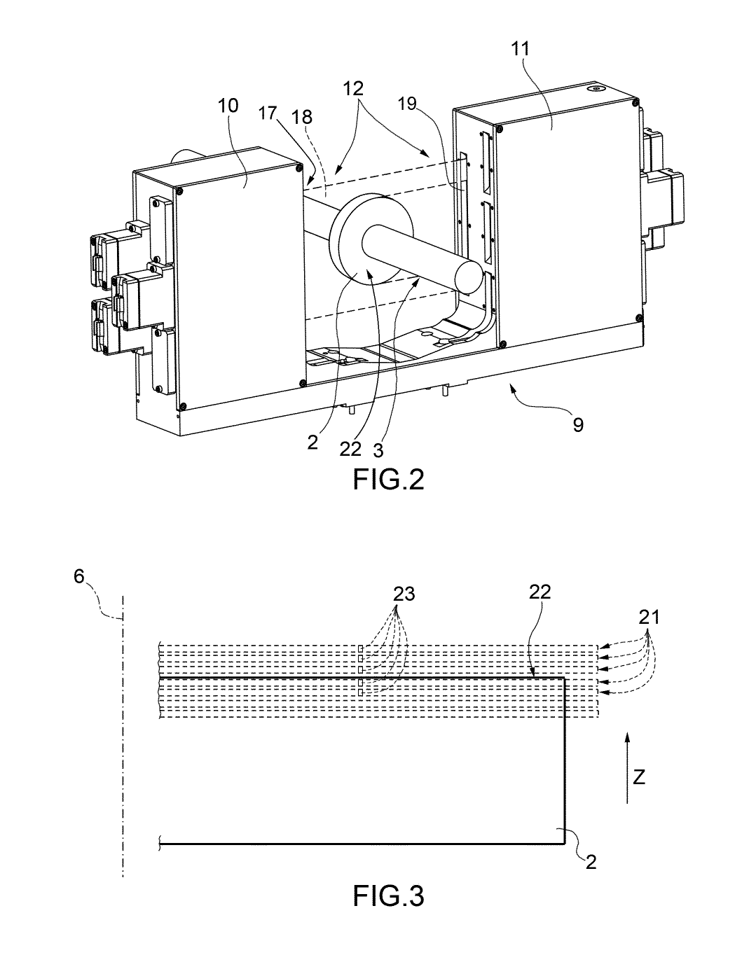

The optoelectronic probe 12 is also shown in FIG. 2 that is a top perspective view of the fork 9 with all the parts mounted thereon, and includes an illuminator 17 which is adapted to emit a beam 18 of parallel rays of visible light or infrared radiation and is arranged on the arm 10 of the fork 9 in such a way that the beam 18 is parallel to a plane perpendicular to the axis of rotation 6. The optoelectronic probe 12 also includes a linear image sensor 19 (FIG. 2), which is arranged on the arm 11 so as to be aligned with the illuminator 17, and so is oriented parallel to a plane perpendicular to the axis of rotation 6, for acquiring images of the workpiece 2 according to the shadow casting technique.

The illuminator 17 and the linear image sensor 19 are provided with respective telecentric or bi-telecentric optics to ensure that the rays of the beam 18 are parallel to one another. The linear image sensor 19 is of a known type and comprises an array of elements, sensitive to visible light or to infrared radiation, that are arranged along a line in order to acquire a linear image having only one pixel width.

The measuring assembly 1 comprises an electronic control unit 20 configured to control the motors 15 and 16 and the optoelectronic sensor 12 so as to implement the method for measuring the axial runout or TIR of the present invention, as below described in detail.

In a preliminary step, the control unit 20 is programmed to search for the initial position (or height) along the Z direction in which the fork 9 must be placed. This preliminary step includes:

a fast optical scan of the workpiece 2, with a low scanning rate, i.e. a scan with an advancing step of relatively large amount along the Z direction, in which the control unit 20 controls the motor 16 and the optoelectronic sensor 12 to acquire the unknown profile of the workpiece 2, and

a subsequent programming of the control unit 20 as a function of the acquired profile so that the control unit 20 itself controls the motor 16 to position the fork 9 in the vicinity of the area to be inspected of the workpiece 2 which includes the plane surface 22 to be measured.

In particular, an operator locates, in the acquired profile of the workpiece 2, a reference item and an initial distance between the reference item and the area to be inspected and then programs the control unit 20 to take into account the reference item and this initial distance. The control unit 20 is configured to control the motor 16 and the optoelectronic sensor 12 so as to search for the reference item and to position the optoelectronic sensor 12 at the initial distance from the reference item. In substance, the initial position along the Z direction at which the fork 19 must be located is determined as a function of the above mentioned reference item and initial distance.

At this point the steps more closely related to the measurement of the axial runout start.

A first optical scanning is performed by the optoelectronic sensor 12, while the workpiece 2 does not rotate, that is an optical scanning of the workpiece 2 with the latter standing at a certain angular position θ₀, by controlling the motor 16 so that the fork 9, and then the optoelectronics probe 12, relatively translates with respect to the workpiece 2 along the Z direction by steps of predetermined amplitudes, comparable with the size of the pixels of the linear image sensor 19, that is of the same order of magnitude as the size of the pixels of the linear image sensor 19.

Typically, the amplitudes of the steps of relative translation between the fork 9 and the workpiece 2 during the first optical scanning of the non-rotating workpiece are defined by a translation that is temporally intermittent and regular, that is according to a first constant time step. Alternatively, the steps of relative translation have constant predetermined amplitude. Preferably, the steps of translation have lower amplitudes than the dimension of the pixels of the linear image sensor 19. For example, if the pixels of the linear image sensor 19 have a size of 7×7 microns, then the step amplitude is substantially equal to 3 microns. The first optical scanning of the non-rotating workpiece extends along the Z direction through a sufficiently large area around the plane surface 22 of the workpiece 2 to be checked.

By means of the first optical scanning of the non-rotating workpiece, a sequence of first linear images parallel to a plane perpendicular to the axis of rotation 6 and distributed along the direction Z is acquired. FIG. 3 illustrates, according to a view parallel to the axis 6 that is simplified and in an enlarged scale with respect to FIGS. 1 and 2, a side portion of the workpiece 2 and the position of the linear images, indicated with reference number 21, of the sequence acquired with the first optical scanning of the non-rotating workpiece. From the acquired first linear images a first light intensity trend I1 of a certain pixel of the image sensor 19 is obtained as the relative position between the workpiece 2 and the optoelectronics probe 12 along the direction Z varies. Reference number 23 indicates the position of the said pixel in the images 21. In particular, the light intensity trends of all the pixels of the image sensor 19 are obtained, and among these the trend that presents the greatest variation in the light intensity is chosen. According to an advantageous alternative solution, among the trends of light intensity of all the pixels of the image sensors 19 the most significant ones are chosen, for example those having a light intensity variation that exceeds a certain relative variability threshold, and the first light intensity trend I1 is obtained as an average of such most significant ones that have been chosen. For example, the relative variability threshold is a predetermined percentage of the maximum light intensity variation between the light intensity trends of all the pixels.

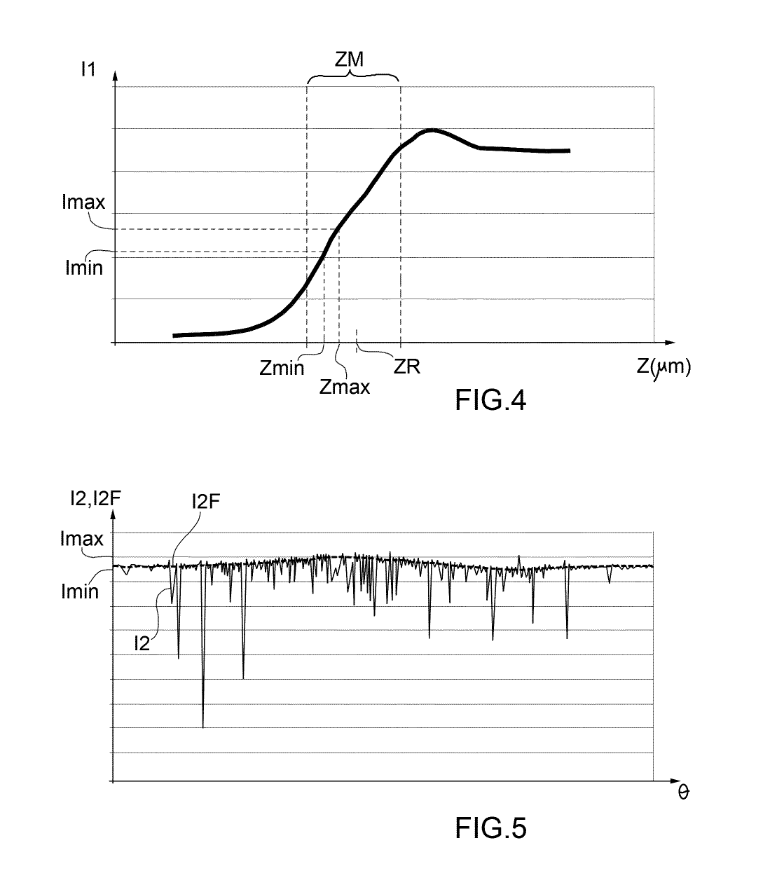

FIG. 4 is a graph of an example of the first light intensity trend I1 relative to a pixel of the image sensor 19 that is centrally arranged in a half-portion of the sensor itself. The first light intensity trend I1 is stored as a data table in an internal memory of the electronic control unit 20.

At this point, a positions range ZM, wherein the first light intensity trend I1 has a monotonous trend, is defined and a relative position ZR of the plane surface 22 is determined as the intermediate position of the positions range ZM.

The optoelectronic probe 12 is moved and placed in the relative position ZR of the plane surface 22 and controlled to perform a second optical scanning of the rotating workpiece, more specifically an optical scanning of the workpiece 2 while the rotating holding mechanism 5 rotates the workpiece 2, for example of a 360° angle about the axis of rotation 6, in angular steps of predetermined amplitudes. Typically, the amplitudes of the angular rotation steps of the workpiece 2 during the second optical scanning of the rotating workpiece are defined by a regular temporally intermittent rotation, in accordance with a second constant time step. Alternatively, the angular rotation steps of the workpiece 2 during the second optical scanning of the rotating workpiece have a constant predetermined amplitude.

By means of the second optical scanning of the rotating workpiece, a sequence of second linear images at the same height or position along the Z direction, more specifically at the relative position ZR of the plane surface, is acquired. The linear images of the acquired sequence are associated to respective angular positions θₙ of the workpiece 2 around the axis of rotation 6. The rotation of the workpiece 2 changes the light intensity received by each pixel of the image sensor 19. From the second linear images acquired by means of the second optical scanning of the rotating workpiece a second light intensity trend I2 of the pixel 23 as the angular position θ of the workpiece 2 varies is obtained and, from the second light intensity trend, at least two intensity values are obtained as follows.

The second light intensity trend I2 is filtered to remove the light variation peaks due to surface irregularities of the workpiece, more specifically of the surface 22. The filtering of the second light intensity trend I2 is carried out, for instance, via a robust spline filter up to the fifteenth harmonic, or through a Fourier filter.

FIG. 5 is a graph of a possible second light intensity trend I2 relative to the same pixel of the first light intensity trend I1 of FIG. 4 and of the corresponding filtered series of light intensity values, indicated with reference I2F.

Similarly to the first light intensity trend I1, the second light intensity trend I2 and the filtered series of light intensity values I2F are stored as respective tables of data in the internal memory of the electronic control unit 20.

In the filtered series of light intensity values I2F a maximum light intensity value Imax and a minimum light intensity value Imin are selected (FIG. 5). The maximum and minimum light intensity values Imax and Imin are used as input data of the first light intensity trend I1 to select from the latter a maximum position value Zmax and a minimum position value Zmin corresponding, respectively, to the maximum light intensity value Imax and to the minimum light intensity value Imin (FIG. 4). The axial runout or axial TIR is calculated as the difference between the maximum position value Zmax and the minimum position value Zmin.

It may happen that the maximum light intensity value Imax or the minimum light intensity value Imin corresponds to a section where the second light intensity trend I2 is saturated, that is a section in which the detected light intensity is substantially constant, according to a certain first tolerance, and, according to a second tolerance it is substantially equal to a light intensity value that corresponds to “full light” or, respectively, to a light intensity value which corresponds to “full dark”, as the angular position θ of the workpiece 2 varies. This means that the position of the workpiece 2 at which the second optical scanning of the non-rotating workpiece is performed is not the optimal one. In this case, the maximum position value Zmax or the minimum position value Zmin corresponding, respectively, to the maximum Imax and minimum Imin light intensity values, falls outside the positions range ZM. In this situation, the optoelectronic probe 12 is moved in the direction of the maximum position value Zmax or, respectively, the minimum position value Zmin, that got out of the positions range ZM and is stopped in a new relative position ZR of the plane surface, which is determined by summing to or, respectively, subtracting from the old relative position ZR an amount equal to half the positions range ZM and is controlled to perform a further second optical scanning of the rotating workpiece in order to acquire further images on which the above procedure is subsequently repeated to obtain a new maximum position value Zmax and/or a new minimum position value Zmin.

The process which comprises the determination of a new relative position ZR of the plane surface, the further second optical scanning of the rotating workpiece performed in correspondence to the new relative position ZR and the obtaining of the new maximum Zmax and minimum Zmin position values from the images acquired by means of the second optical scanning of the rotating workpiece is repeated until the second light intensity trend I2 is devoid of traits of saturation.

According to an alternative embodiment of the present invention, not shown in the drawings, a series of light intensity values in the entire range the second light intensity trend I2 is used as input data of the first light intensity trend I1 to select from the latter a corresponding series of corresponding position values which is filtered to remove the position variation peaks corresponding to the light intensity variation peaks variation due to surface irregularities of the workpiece 2, more specifically of surface 22, thus obtaining a filtered series of position values I1F. Even in this case, the filtering of the series of position values is carried out, for instance, via a robust spline filter up to the fifteenth harmonic, or through a Fourier filter. From the filtered series of position values I1F the maximum position value Zmax and the minimum position value Zmin are selected.

The main advantage of the measuring method and of the corresponding measuring assembly 1 according to the present invention is to significantly reduce the time for measuring the axial runout of a plane surface 22 of a workpiece 2 by optical means, by using an optoelectronic probe 12 capable of acquiring linear images according to the shadow casting technique. In fact, the method according to the present invention requires only two optical scannings of the workpiece 2, a first optical scanning of the non-rotating workpiece while moving the optoelectronic probe 12 along a Z direction parallel to the axis of rotation 6 of the workpiece 2, and a second optical scanning of the rotating workpiece 2 while the optoelectronic probe 12 stands stationary at a certain position and the workpiece 2 makes a complete revolution around the axis of rotation 6.

1. A method for measuring the axial runout or orthogonality error of a plane surface of a workpiece with respect to an axis of rotation via an optoelectronic probe provided with a linear image sensor oriented parallel to a plane perpendicular to the axis of rotation, the method comprising:
performing, via the optoelectronic probe, a first optical scanning of the workpiece standing at a certain angular position, via a relative translation between the workpiece and the optoelectronic probe along a direction parallel to the axis of rotation to obtain a first light intensity trend of at least one pixel of the linear image sensor as the relative position between the workpiece and the optoelectronic probe along said direction varies;
determining a relative position of the plane surface of the workpiece as an intermediate position in a position range in which the first light intensity trend has a monotonic trend;
performing a second optical scanning of the workpiece via the optoelectronic probe in the relative position of the plane surface of the workpiece while the workpiece rotates with respect to the axis of rotation to obtain a second light intensity trend of said at least one pixel as the angular position of the workpiece around the axis of rotation varies;
obtaining at least two light intensity values from the second light intensity trend;
in the first light intensity trend, selecting at least two position values corresponding to said at least two light intensity values;
on the basis of said at least two position values, determining a maximum position value and a minimum position value from the first light intensity trend; and
calculating said axial runout as the difference between the maximum position value and the minimum position value.

2. The method according to claim 1, wherein the determination of said maximum position value and said minimum position value includes:
filtering the second light intensity trend to remove light variation peaks due to surface irregularities of the workpiece so as to obtain a filtered series of light intensity values;
selecting said at least two light intensity values as a maximum light intensity value and a minimum light intensity value from the filtered series of light intensity values; and
determining said maximum position value and said minimum position value as position values corresponding, in the first light intensity trend, to said maximum light intensity value and minimum light intensity value, respectively.

3. The method according to claim 2, wherein the filtering of said second light intensity trend is made via a robust spline filter filtering up to the fifteenth harmonic, or via a Fourier filter.

4. The method according to claim 1, wherein the determination of said maximum position value and said minimum position value includes:
selecting a series of position values corresponding, in said first light intensity trend, to the light intensity values of said second light intensity trend;
filtering the series of position values to remove position variation peaks due to surface irregularities of the workpiece so as to obtain a filtered series of position values; and
selecting said maximum position value and said minimum position value from the filtered series of position values.

5. The method according to claim 4, in which the filtering of said series of position values is effected via a robust spline filter filtering up to the fifteenth harmonic, or via a Fourier filter.

6. The method according to claim 1, wherein said optoelectronic probe comprises an illuminator adapted to emit a beam of parallel rays of visible light or infrared radiation, said beam being parallel to said plane orthogonal to the axis of rotation, said illuminator and the linear image sensor being located on opposite sides of the axis of rotation of the workpiece to acquire images according to the shadow casting technique.

7. The method according to claim 1, wherein the performance of said first optical scanning of the workpiece comprises:
acquiring, via the optoelectronic probe during the relative translation along said direction, a sequence of first linear images parallel to said plane and distributed along said direction; and
obtaining said first light intensity trend from said first linear images.

8. The method according to claim 7, wherein obtaining said first light intensity trend from said first linear images comprises:
obtaining light intensity trends of all the pixels of said linear image sensor from the first linear images; and
selecting a light intensity trend that features the greatest light intensity variation out of said light intensity trends of all the pixels.

9. The method according to claim 7, wherein obtaining said first light intensity trend from said first linear images comprises:
obtaining light intensity trends of all the pixels of said linear image sensor from the first linear images; and
selecting light intensity trends that feature a light intensity variation exceeding a certain relative variability threshold out of said light intensity trends of all the pixels.

10. The method according to claim 7, in which the relative translation between the workpiece and the optoelectronic probe along said direction takes place in steps having predetermined amplitudes of the same order of magnitude as the size of said at least one pixel or less than the size of said at least one pixel, and defined by a temporally intermittent and regular translation.

11. The method according to claim 1, wherein the performance of said second optical scanning of the workpiece comprises:
acquiring, in the relative position of the plane surface of the workpiece, via the optoelectronic probe, a sequence of second linear images associated with respective angular positions of the workpiece around said axis of rotation; and
obtaining said second light intensity trend from said second linear images.

12. The method according to claim 11, wherein the rotation of the workpiece about the axis of rotation takes place in angular steps having predetermined amplitudes defined by a temporally intermittent and regular rotation.

13. A measuring assembly for measuring the axial runout or orthogonality error of a plane surface of a workpiece with respect to an axis of rotation of the workpiece, the measuring assembly comprising a motorized rotating holding mechanism for retaining the workpiece such that the workpiece rotates with respect to the axis of rotation, an optoelectronic probe provided with a linear image sensor to acquire linear images of the workpiece, a motorized movable support for supporting the optoelectronic probe in such a way that the linear image sensor is oriented parallel to a plane perpendicular to the axis of rotation and for translating the optoelectronic probe along a first direction parallel to the axis of rotation, and an electronic control unit configured to control the rotation of the rotating holding mechanism, the translation of the movable support, and the optoelectronic probe, and to implement the steps of a method according to claim 1.

14. The measuring assembly according to claim 13, wherein the electronic control unit is configured to implement the steps of a method according to claim 2.

15. The measuring assembly according to claim 13, wherein the electronic control unit is configured to implement the steps of a method according to claim 4.
